(19) United States
(12) Patent Application Publication
(10) Pub. No.: US 2005/0237882 A1
(43) Pub. Date: Oct. 27, 2005

(54) Tracking balance adjustment device

(75) Inventor: Yuzuru Honobe, Saitama-ken (JP)

Correspondence Address: SoCAL IP LAW GROUP LLP, 310 N. WESTLAKE BLVD. STE 120, WESTLAKE VILLAGE, CA, 91362, US

(73) Assignee: Sanyo Electric Co., Ltd., Osaka (JP)

(21) Appl. No.: 11/111,441

(22) Filed: Apr. 20, 2005

(30) Foreign Application Priority Data
Apr. 23, 2004 (JP) 2004-128341

(51) Int. Cl. G11B 7/09; G11B 7/095

(52) U.S. Cl. 369/44.37; 369/44.41; 369/53.23

(57) ABSTRACT

A tracking balance adjustment device carries out a balance adjustment, when laser beams emitted from a laser element are caused to track a track on the optical disk, to bring the DC component of a tracking error signal equal to a preset DC reference value by obtaining two photodetection signals opposite to each other in phase that represent a deviation in the tracking based on return beams of the laser beams from the optical disk and carrying out the tracking servo control based on the tracking error signal obtained from the difference between the two photodetection signals. The tracking balance adjustment device has a first amplifier operable to amplify one of the photodetection signals, a second amplifier operable to amplify the other photodetection signal, and a tracking balance adjustment unit operable to adjust the offset of the first amplifier so as to bring the DC component of the output of the first amplifier equal to the DC reference value and to adjust the offset of the second amplifier so as to bring the DC component of the output of the second amplifier equal to the DC reference value.

### CROSS-REFERENCE TO RELATED APPLICATIONS

The present application claims priority upon Japanese Patent Application No. 2004-128341 filed on Apr. 23, 2004, which is herein incorporated by reference.

### BACKGROUND OF THE INVENTION

1. Field of the Invention

The present invention relates to a tracking balance adjustment device.

2. Description of the Related Art

When reading information recorded in the target track of an optical disk, an optical disk apparatus carries out a tracking servo control based on a tracking error signal so as to cause laser beams, emitted from a laser element provided on the optical pickup, to track (follow) the target track.

The three-beam system is described as an example of the system adapted to generate a tracking error signal. With the optical pickup employing the three-beam system, three laser beams or a main beam and sub-beams 1 and 2 are emitted separately as illustrated in FIG. 10. It is to be noted that the main beam is used to read the information recorded in the target track. On the other hand, the sub-beams 1 and 2 are each irradiated onto the positions that are respectively point-symmetrical to the main beam, and the tracking error signal is generated from the difference therebetween. Therefore, the tracking error signal is at the zero level when the main beam is irradiated onto the target track, whereas if the main beam is irradiated onto a position deviated from the target track, the tracking error signal is at a positive or negative level corresponding to the deviation.

FIG. 11 illustrates an example of a conventional system adapted to generate the tracking error signal. In this figure, return beams of the sub-beams 1 and 2 are received respectively by light receiving units 10 and 20 of a photodetector. Here, the light receiving units 10 and 20 of the photodetector generate photodetection signals E and F (light-receiving currents) that are opposite to each other in phase. Then, these signals are converted to sub-beam signals VIN1 and VIN2 having voltage levels proportional to the current levels of the photodetection signals E and F by I/V converters 11 and 21. The sub-beam signals VIN1 and VIN2 are supplied to variable gain amplifiers 60 and 70 for amplification with a given amplification factor. The amplified outputs of the variable gain amplifiers 60 and 70 are supplied respectively to the inverting and non-inverting input terminals of a differential amplifier 80 to generate a tracking error signal.

Incidentally, as regards to the tracking error signal, it is preferred that, to prevent susceptibility to off-track resulting from a side slide during the tracking servo pull-in or a disturbance (vibrations) during the tracking servo operation, the tracking deviations in the inner and outer circumferential directions relative to the target track be uniformly detected.

However, characteristic variations such as gain and offset occur between the electronic components (the light receiving unit 10, the I/V converter 11 and the variable gain amplifier 60) making up the signal processing system for the sub-beam 1 and those (the light receiving unit 20, the I/V converter 21 and the variable gain amplifier 70) making up the signal processing system for the sub-beam 2. Moreover, the differential amplifier 80 eventually generating the tracking error signal also has an offset and a potential gain error.

For this reason, the DC component of the tracking error signal is not at the zero level. Instead, the tracking error signal assumes an unbalanced state between the positive and negative polarity levels relative to the zero level. This requires the tracking balance adjustment so as to bring the DC component of the tracking error signal equal to the zero level.

In the conventional example illustrated in FIG. 11, a tracking balance adjustment unit 90, normally implemented as a function of a DSP (Digital Signal Processor), has commonly adjusted the gains of the variable gain amplifiers 60 and 70 for tracking balance adjustment, for example, based on the intermediate value of the tracking error signal between the maximum and minimum values thereof or the DC tracking error signal converted by an LPF (Low Pass Filter) so as to eliminate the DC component of the tracking error signal. See, e.g., Japanese Patent Application Laid-open Publication No. 10-124892.

Incidentally, recent years have seen a spotlight focused on the integration technology using the CMOS process. As a result, integration by the CMOS process is also demanded of the analog/digital signal processing circuitry for optical disk apparatuses including the tracking error signal generation system as illustrated in FIG. 11.

In the conventional example illustrated in FIG. 11, however, negative feedback portions of operational amplifiers (commonly called op-amps) 610 and 710 making up the variable gain amplifiers 60 and 70 are provided with ladder resistors 611 and 711 having the number of resistors corresponding to the gain adjustment resolution as an arrangement adapted to adjust the gain. For example, if the gain adjustment resolution is eight bits, the number of resistors making up each of the ladder resistors 611 and 711 is 255 (two to the eighth power-one). On the other hand, the tracking balance adjustment unit 90 requires a complex logic to switch ON/OFF the selector switches provided in each of the ladder resistors 611 and 711 based on the DC component of the tracking error signal.

To integrate the components such as the ladder resistors 611 and 711 and the switching circuits for the selector switches into a single-chip LSI, therefore, the circuit scale of the LSI becomes large due to a plurality of the resistors in the ladder resistors 611 and 711 and the complex logic adapted to switch ON/OFF the selector switches, thus resulting in difficulty in integrating such components.

### SUMMARY OF THE INVENTION

In order to solve the above and other problems, according to one aspect of the present invention there is provided a tracking balance adjustment device for carrying out the balance adjustment, when laser beams emitted from a laser element are caused to track a track on the optical disk, to bring the DC component of a tracking error signal equal to a preset DC reference value by obtaining two photodetection signals opposite to each other in phase that represent a deviation in the tracking based on return beams of the laser beams from the optical disk and carrying out the tracking servo control based on the tracking error signal obtained from the difference between the two photodetection signals. The tracking balance adjustment device has a first amplifier operable to amplify one of the photodetection signals, a second amplifier operable to amplify the other photodetection signal, and a tracking balance adjustment unit operable to adjust the offset of the first amplifier so as to bring the DC component of the output of the first amplifier equal to the DC reference value and to adjust the offset of the second amplifier so as to bring the DC component of the output of the second amplifier equal to the DC reference value when laser beams emitted from the laser element are caused to track a track on the optical disk.

The present invention can thus provide a tracking balance adjustment device suited to integration.

### BRIEF DESCRIPTION OF THE DRAWINGS

For a more complete understanding of the present invention and the advantages thereof, reference is now made to the following description taken in conjunction with the accompanying drawings wherein:

FIG. 1 illustrates the system configuration of a tracking servo control system according to an embodiment of the present invention;

FIG. 2 illustrates the detailed configuration of two photodetection signal processing systems according to an embodiment of the present invention;

FIG. 3 is a flowchart describing a tracking balance adjustment process according to an embodiment of the present invention;

FIG. 4 is a flowchart describing the tracking balance adjustment process according to an embodiment of the present invention;

FIG. 5 is a waveform diagram of major signals according to an embodiment of the present invention;

FIG. 6 is a flowchart describing the tracking balance adjustment process according to an embodiment of the present invention;

FIG. 7 is a flowchart describing the tracking balance adjustment process according to an embodiment of the present invention;

FIG. 8 is a waveform diagram of major signals according to an embodiment of the present invention;

FIG. 9 is a waveform diagram of major signals according to an embodiment of the present invention;

FIG. 10 is an explanatory view of the three-beam system; and

FIG. 11 illustrates the configuration of a conventional tracking error signal generation system.

### DETAILED DESCRIPTION OF THE INVENTION

At least the following will become apparent from the description of the specification and the attached drawings.

<System Configuration>

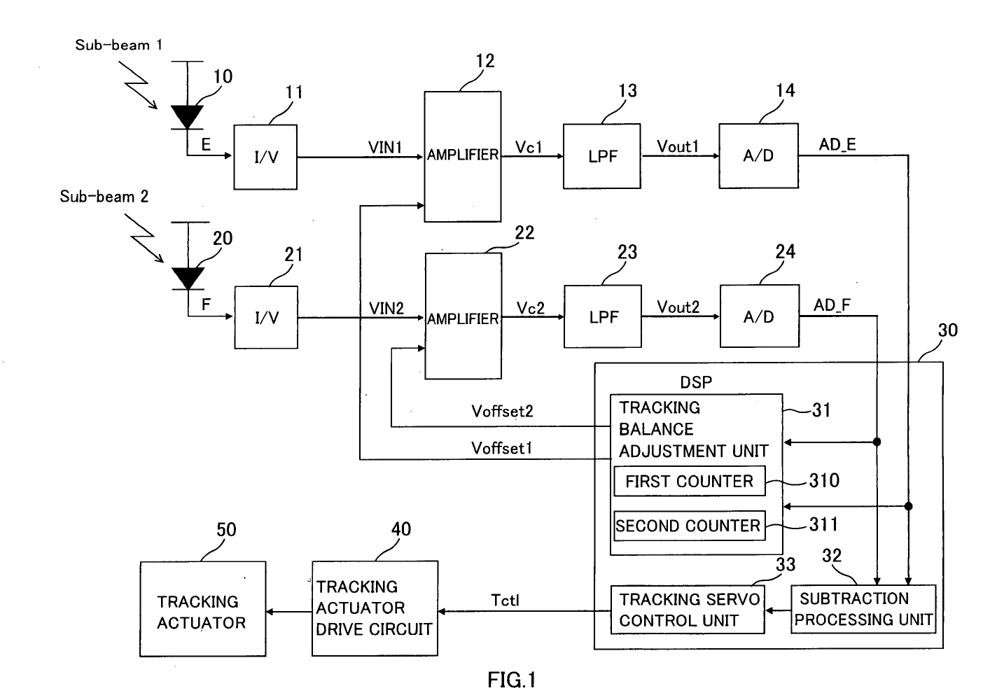

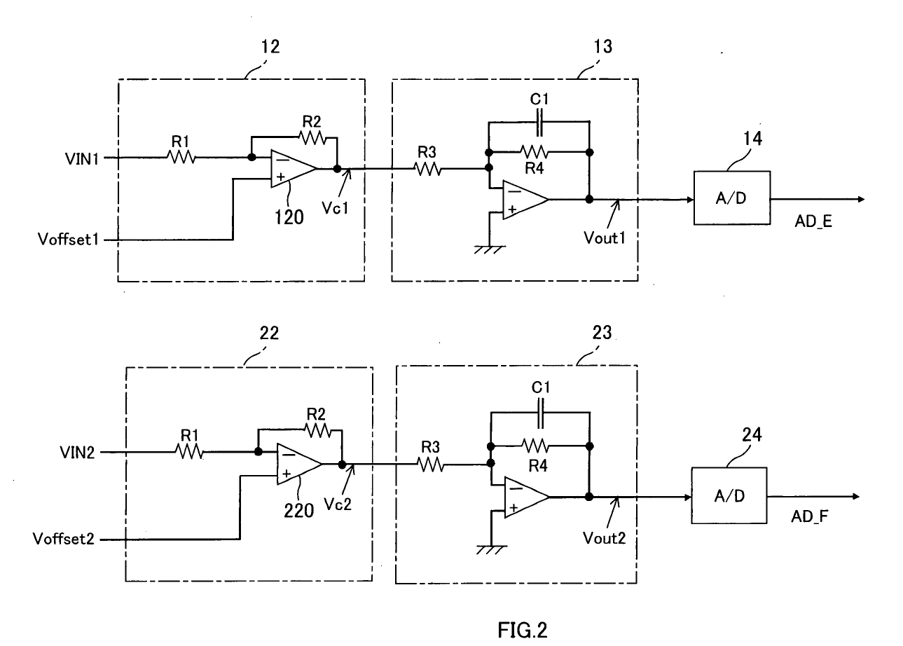

Description will be given of the system configuration of a tracking servo control system according to an embodiment of the present invention based on FIGS. 1 and 2. It is to be noted that a DSP 30 (in particular, a tracking balance adjustment unit 31), amplifiers 12 and 22, LPFs 13 and 23 and A/D converters 14 and 24 are each an embodiment of the tracking balance adjustment device according to the present invention.

First, we assume that an optical pickup (not shown) according to the present invention employs the three-beam system to generate a tracking error signal. That is, the optical pickup according to the present invention has an optical system including a laser element operable to emit a main beam and two sub-beams to the optical disk as illustrated in FIG. 8 and a photodetector operable to detect the return beams from the optical disk. It is to be noted that the photodetector is separated into three units, namely, a light receiving unit for the return beam of the main beam and the light receiving units 10 and 20 for the return beams of the sub-beams 1 and 2.

The light receiving units 10 and 20 of the photodetector generate the photodetection signals E and F that are opposite to each other in phase. Then, these signals are converted to the sub-beam signals VIN1 and VIN2 having voltage levels proportional to the current levels of the photodetection signals E and F by the I/V converters 11 and 21. The sub-beam signals VIN1 and VIN2 are supplied to the amplifiers 12 and 22 and amplified with a given amplification factor. Then, amplified outputs Vc1 and Vc2 of the amplifiers 12 and 22 are removed of high-frequency components by the LPFs 13 and 23 and then converted to digital signals AD_E and AD_F by the A/D converters 14 and 24.

It is to be noted that the amplifiers 12 and 22 are implemented with operational amplifiers (commonly called op-amps) 120 and 220 as illustrated in FIG. 2. Here, the sub-beam signals VIN1 and VIN2 are supplied respectively to the inverting input terminals of the operational amplifiers 120 and 220 via an input resistor R1, and the amplified output Vc1 is also supplied via a feedback resistor R2. On the other hand, control voltages Voffset1 and Voffset2 for balance adjustment, that will be described later, are supplied to the non-inverting input terminals of the operational amplifiers 120 and 220. Therefore, the amplified outputs Vc1 and Vc2 of the operational amplifiers 120 and 220 can be expressed by formula 1 below.
Vc1, Vc2=(−R2/R1×VIN1, VIN2)+((1+R2/R1)×Voffset1, Voffset2) [Formula 1]

The LPFs 13 and 23 are also configured by connecting a capacitive element C1 in parallel with a feedback resistor R4 of an operational amplifier as illustrated in FIG. 2. In this case, outputs Vout1 and Vout2 of the LPFs 13 and 23 can be expressed by formula 2 below.
Vout1 or Vout2=−R4/((1+jωC1×R4)×R3)×Vc1, Vc2 [Formula 2]

The DSP (Digital Signal Processor) 30 is a digital signal processing circuit incorporating digital servo function designed for optical disk apparatuses. It is to be noted that the tracking servo and tracking balance functions, in particular, are configured with hardware or software as the digital servo functions in the DSP 30.

Description will be given first of an embodiment of the tracking servo function available with the DSP 30. The DSP 30 receives AD_E and AD_F from the A/D converters 14 and 24 and carries out a subtraction “AD_E−AD_F” with a subtraction processing unit 32 to generate a tracking error signal. A tracking servo control unit 33 receives the tracking error signal from the subtraction processing unit 32 to convert the signal to a tracking drive signal Tct1.

The tracking drive signal Tct1 is supplied to a tracking actuator 50 via a tracking actuator drive circuit 40. As a result, the tracking servo control is carried out to drive and control an objective lens of the optical pickup in the direction of the diameter of the optical disk so as to cause laser beams, emitted from the objective lens, to track (follow) the target track.

Description will be given next of the tracking balance adjustment unit 31 as an embodiment of the tracking balance adjustment function available with the DSP 30.

The tracking balance adjustment unit 31 is designed to adjust the tracking balance such that the DC component of the tracking error signal agrees with a given DC reference value so as to ensure that the tracking deviations in the inner and outer circumferential directions relative to the target track are uniformly detected. It is to be noted that although being basically the zero level, the given DC reference value is, for example, set to a bit string equivalent to the zero level±several LSBs (Least Significant bits/bytes) due to resolution limits of the A/D converters.

That is, the tracking balance adjustment unit 31 supplies the control voltages Voffset1 and Voffset2, adapted to adjust the offsets of the amplifiers 12 and 22, to the non-inverting input terminals of the operational amplifiers 120 and 220 to carry out the tracking balance adjustment so as to eliminate the DC component detected from the outputs AD_E and AD_F of the A/D converters 14 and 24. It is to be noted that the control voltages Voffset1 and Voffset2 are D/A converted by the D/A converters that are not shown in the process of supply from the tracking balance adjustment unit 31 to the operational amplifiers 120 and 220.

As a result, both the output AD_E of the A/D converter 14 and the AD_F of the A/D converter 24 assume a balanced state between the positive and negative polarity levels relative to the zero level. At this time, the tracking error signal, obtained from the difference between the outputs AD_E and AD_F also assumes a balanced state having zero DC component.

It is to be noted that the tracking balance adjustment unit 31 is preferably provided with a first counter 310 operable to set a time period to detect the DC components from the outputs AD_E and AD_F of the A/D converters 14 and 24, and a second counter 311 operable to set the number of times the offset adjustment of the operational amplifiers 120 and 220 is to be repeated. The first and second counters 310 and 311 can suppress the effect of disturbance noise, thus providing improved accuracy in the tracking balance adjustment.

<Tracking Balance Adjustment>

===Detection of the DC Component from the Maximum and Minimum Values of AD_E and AD_F===

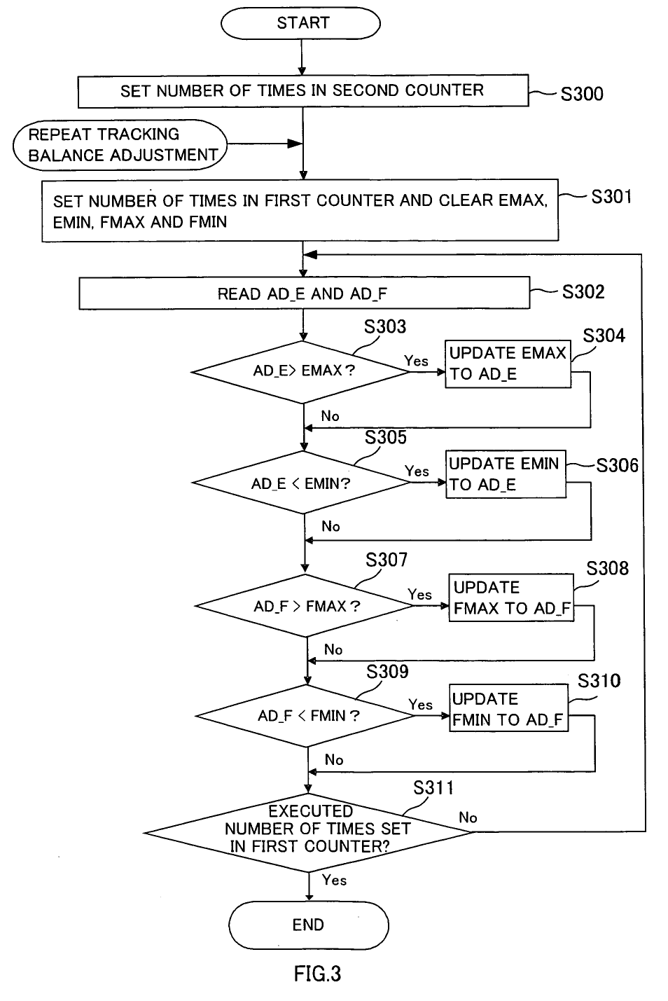

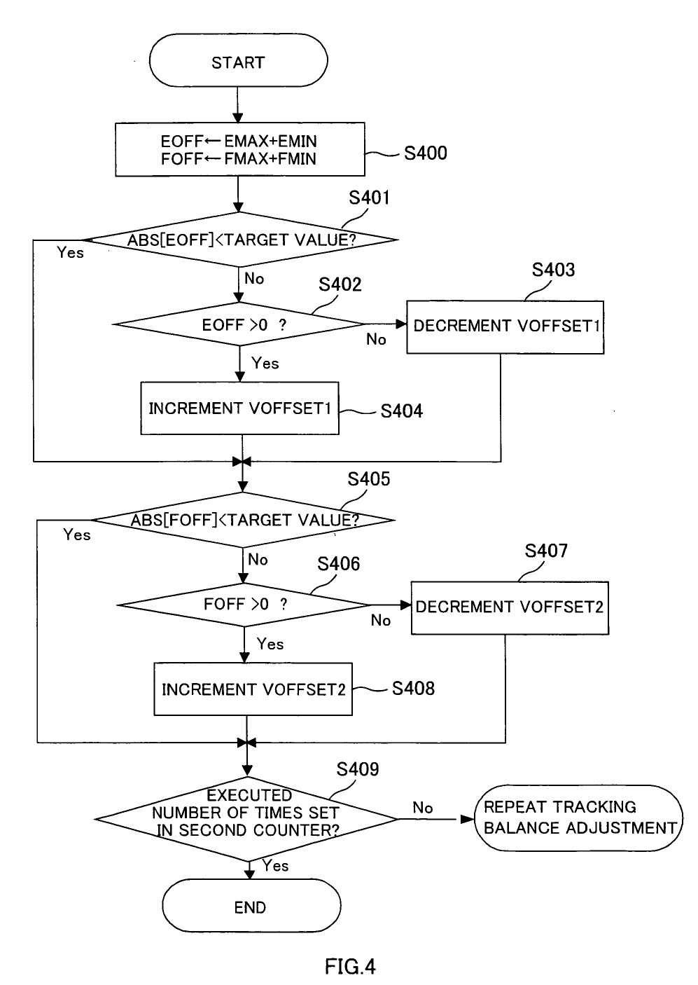

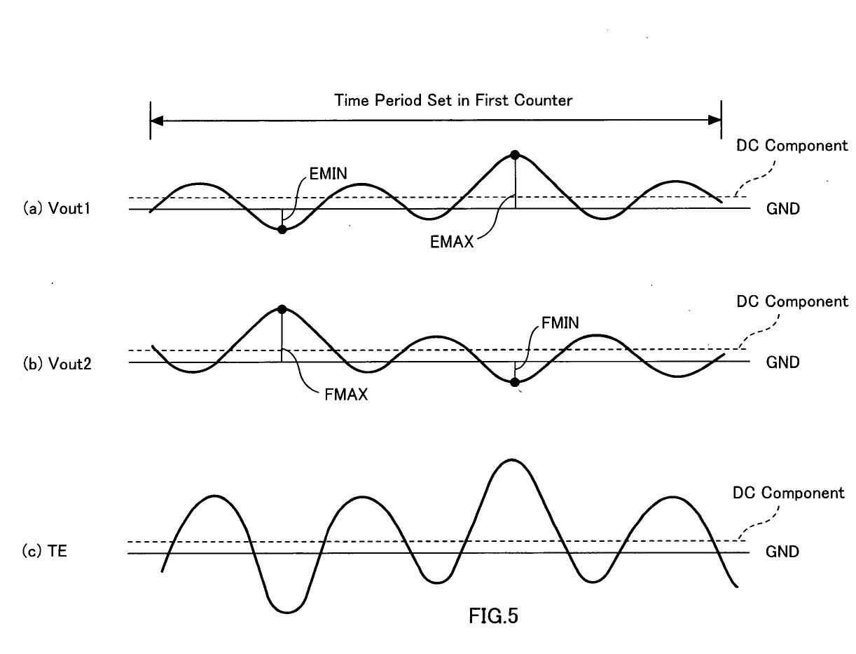

Description will be given of the tracking balance adjustment flow according to an embodiment of the present invention based on FIGS. 3 and 4, and with reference to FIG. 5 as necessary. It is to be noted that the present embodiment detects the DC components of the outputs AD_E and AD_F of the A/D converters 14 and 24 based on the maximum and minimum values. It is also to be noted that the DSP 30 plays a central role in the operation in the description of the flowcharts illustrated in FIGS. 3 and 4 unless otherwise noted.

First, the DSP 30 exercises control so as to disable the tracking servo control of the tracking servo control unit 33 before initiating the tracking balance adjustment. It is to be noted that the tracking servo loop is turned off to disable the tracking servo control.

Here, if the tracking servo control is disabled, the laser beams are interrupted from tracking the target track on the optical disk. This causes the laser beam spot positions to cross the tracks on the optical disk. At this time, the outputs Vout1 and Vout2 of the LPFs 13 and 23 and the tracking error signal present, for example, the sinusoidal waveforms as illustrated in FIG. 5. On the other hand, the individual DC components superposed on outputs Vout1 and Vout2 of the LPFs 13 and 23 and the tracking error signal, are deviated from the zero level that serves as the reference.

In such a condition, the tracking balance adjustment unit 31 sets in the second counter 311 the number of times the offset adjustment of the operational amplifiers 120 and 220 is to be repeated (S300). Then, the tracking balance adjustment unit 31 sets in the first counter 310 the number of times corresponding to the time period to detect the DC components from the outputs AD_E and AD_F of the A/D converters 14 and 24, and resets the contents of preset parameters EMAX, EMIN, FMAX and FMIN to their initial values (S301).

It is to be noted that the parameters EMAX and EMIN respectively store the maximum and minimum values of the output AD_E of the A/D converter 14 during the time period until the number of times, set in the first counter 310, is counted. On the other hand, the parameters FMAX and FMIN respectively store the maximum and minimum values of the output AD_F of the A/D converter 24 during the time period until the number of times, set in the first counter 310, is counted.

When supplied with AD_E and AD_F from the A/D converters 14 and 24 (S302), the tracking balance adjustment unit 31 first determines whether the output AD_E of the A/D converter 14 is larger than the value of the parameter EMAX (S303). If so (S303: YES), the tracking balance adjustment unit 31 updates the value of the parameter EMAX to the current contents of AD_E (S304). If not (S303: NO), the tracking balance adjustment unit 31 determines whether the output AD_E of the A/D converter 14 is smaller than the parameter EMIN (S305). If so (S305: YES), the tracking balance adjustment unit 31 updates the value of the parameter EMIN to the current contents of AD_E (S306).

The tracking balance adjustment unit 31 also processes the parameters FMAX and FMIN through the steps from (S307) to (S310) as with the parameters EMAX and EMIN. At this point, the first processing for the parameters EMAX, EMIN, FMAX and FMIN is complete, and the steps from (S300) to (S310) will be repeated until the number of times set in the first counter 310 is counted (S311: YES).

It is to be noted that the steps from (S303) to (S306) for the parameters EMAX and EMIN may be executed in parallel with the steps from (S307) to (S310) for the parameters FMAX and FMIN.

Next, the tracking balance adjustment unit 31 adds the values of the parameters EMAX and EMIN, that differ from each other in polarity, to find an intermediate value EOFF between the parameters EMAX and EMIN. This intermediate value EOFF constitutes the positive or negative DC component value of the output AD_E of the A/D converter 14 relative to the zero level. The tracking balance adjustment unit 31 also adds the values of the parameters FMAX and FMIN, that differ from each other in polarity, to find an intermediate value FOFF between the parameters FMAX and FMIN. This intermediate value FOFF constitutes the positive or negative DC component value of the output AD_F of the A/D converter 24 relative to the zero level (S400).

Then, the tracking balance adjustment unit 31 determines whether an absolute value ABS[EOFF] of the intermediate value EOFF is smaller than a given target value (e.g., bit string equivalent to the zero level±several LSBS) (S401). When the absolute value ABS[EOFF] is smaller than the given target value (S401: YES), the output AD_E of the A/D converter 14 is in a balanced state between the positive and negative polarity levels relative to the zero level. Therefore, the tracking balance adjustment unit 31 proceeds on to the processing of the intermediate value FOFF that will be described later. On the other hand, if the absolute value ABS[EOFF] is larger than the given target value (S401: NO), the output AD_E of the A/D converter 14 must be adjusted for balance.

For this reason, when the EOFF is positive (S402: YES), the control voltage Voffset1 is incremented by as much as the level corresponding to the difference between the intermediate value EOFF and the zero level (S404). Thus, the incrementation of the control voltage Voffset1 causes the output Vout1 of the LPF 13 to decline in level due to the aforementioned formulas 1 and 2. This also causes the output AD_E of the A/D converter 14 to decline in level. That is, this means that the control voltage Voffset1 has been adjusted such that the positive intermediate value EOFF becomes equal to the zero level.

On the other hand, when the EOFF is negative (S402: NO), the control voltage Voffset1 is decremented by as much as the level corresponding to the difference between the zero level and the intermediate value EOFF (S403). Thus, the decrementation of the control voltage Voffset1 causes the output Vout1 of the LPF 13 to rise in level due to the aforementioned formulas 1 and 2. This also causes the output AD_E of the A/D converter 14 to rise in level. That is, this means that the control voltage Voffset1 has been adjusted such that the negative intermediate value EOFF becomes equal to the zero level.

The tracking balance adjustment unit 31 also carries out the processing of the intermediate value FOFF through the steps from (S405) to (S408) as with the intermediate value EOFF. The processing of the intermediate value FOFF allows the control voltage Voffset2 to be adjusted such that the positive or negative intermediate value FOFF becomes equal to the zero level.

At this point, the processings of the intermediate values EOFF and FOFF are complete, and the outputs AD_E and AD_F of the A/D converters 14 and 24 have been adjusted for balance. Here, to suppress the effects of disturbance noise and others and ensure improved adjustment accuracy, it is preferred that the steps from (S300) to (S311) and those from (S400) to (S408) be repeated until the number of times set in the second counter 311 is counted (S409: YES).

Thus, following the tracking balance adjustment according to the present invention, the tracking servo control is enabled again. When information, recorded in the optical disk, is read with laser beams emitted from the laser element of the optical pickup, the tracking servo control is carried out based on the tracking error signal that has been subjected to the tracking balance adjustment.

===Detection of the DC Component Through the LPF Operation of AD_E and AD_F===

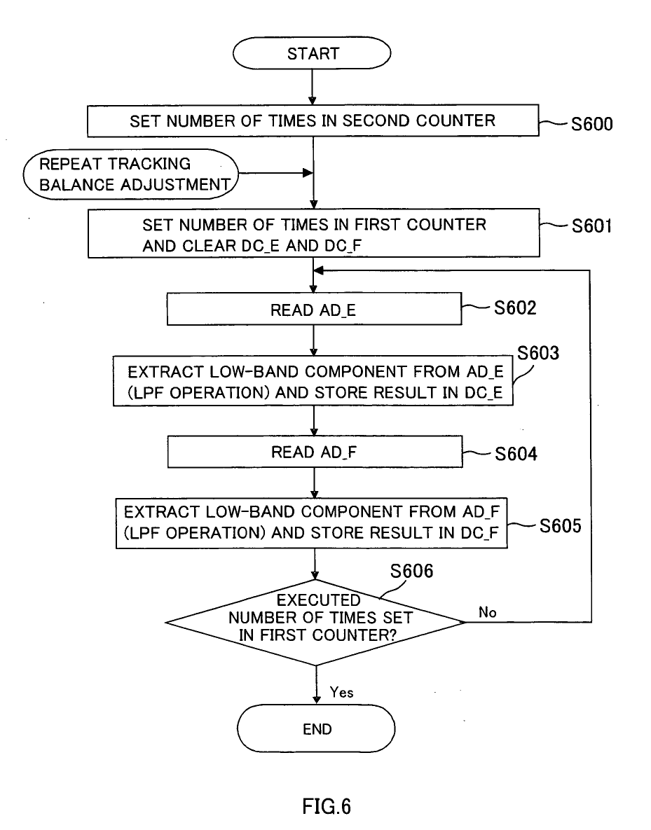

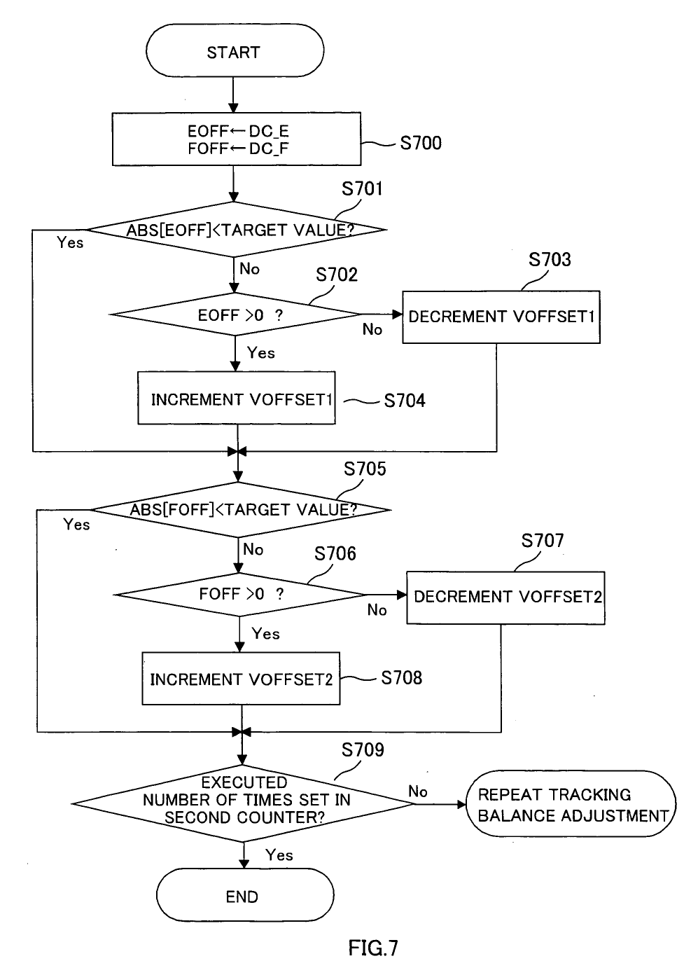

Description will be given of the tracking balance adjustment flow according to another embodiment of the present invention based on FIGS. 6 and 7. It is to be noted that the present embodiment detects the DC components of the outputs AD_E and AD_F of the A/D converters 14 and 24 through the LPF (Low Pass Filter) operation process that will be described later. It is also to be noted that the DSP 30 plays a central role in the operation in the description of the flowcharts illustrated in FIGS. 6 and 7 unless otherwise noted.

As with the aforementioned embodiment, the DSP 30 disables the tracking servo control and interrupts the laser beams from tracking the target track on the optical disk before initiating the tracking balance adjustment. This causes the laser beam spot positions to cross the tracks on the optical disk, and the outputs Vout1 and Vout2 of the LPFs 13 and 23 and the tracking error signal to present the sinusoidal waveforms as illustrated in FIG. 5.

Then, the tracking balance adjustment unit 31 sets in the second counter 311 the number of times the offset adjustment of the operational amplifiers 120 and 220 is to be repeated (S600). Next, the tracking balance adjustment unit 31 sets in the first counter 310 the number of times corresponding to the time period to detect the DC components of the outputs AD_E and AD_F of the A/D converters 14 and 24, and resets the contents of preset parameters DC_E and DC_F to their initial values (S601).

It is to be noted that the parameters DC_E and DC_F store frequency components lower than a given cutoff frequency (hereinafter low-band components) extracted from the outputs AD_E and AD_F of the A/D converters 14 and 24 until the number of times set in the first counter 310 is counted.

When AD_E is supplied from the A/D converter 14 (S602), the tracking balance adjustment unit 31 carries out a digital filtering process (hereinafter referred to as LPF operation process) corresponding to the LPF (Low Pass Filter) on that AD_E to extract and store a low-band component in the parameter DC_E (S603). Then, when AD_F is supplied from the A/D converter 24 (S604), the tracking balance adjustment unit 31 carries out the LPF operation process on that AD_F to extract and store a low-band component in the parameter DC_F (S605).

At this point, the first processing of the parameters DC_E and DC_F is complete, and the steps from (S602) to (S605) will be repeated until the number of times set in the first counter 310 is counted (S606: YES). It is to be noted that the steps from (S602) to (S603) for the parameter DC_E may be executed in parallel with the steps from (S604) to (S605) for the parameter DC_F.

Next, the tracking balance adjustment unit 31 stores the values of the parameters DC_E and DC_F in the low-band components EOFF and FOFF that are parameters made newly available (S700). That is, the low-band components EOFF and FOFF store the values of the positive or negative DC components of the outputs AD_E and AD_F of the A/D converters 14 and 24 relative to the zero level.

The tracking balance adjustment unit 31 determines whether the absolute value ABS[EOFF] of the low-band component EOFF is smaller than a given target value as with the aforementioned embodiment (S701). When the absolute value ABS[EOFF] is smaller than the given target value (S701: YES), the tracking balance adjustment unit 31 proceeds to the processing of the low-band component FOFF.

On the other hand, if the absolute value ABS[EOFF] is larger than the given target value (S701: NO), the output AD_E of the A/D converter 14 must be adjusted for balance. For this reason, when the low-band component EOFF is positive (S702: YES), the control voltage Voffset1 is incremented by as much as the level corresponding to the difference between the low-band component EOFF and the zero level (S704). As a result, the control voltage Voffset1 has been adjusted such that the positive low-band component EOFF becomes equal to the zero level. On the other hand, when the low-band component EOFF is negative (S702: NO), the control voltage Voffset1 is decremented by as much as the level corresponding to the difference between the zero level and the low-band component EOFF (S703). As a result, the control voltage Voffset1 has been adjusted such that the negative low-band component EOFF becomes equal to the zero level.

Then, the tracking balance adjustment unit 31 carries out the processing of the low-band component FOFF through the steps from (S705) to (S708) as with the low-band component EOFF. The processing of the low-band component FOFF allows the control voltage Voffset2 to be adjusted such that the positive or negative low-band component FOFF becomes equal to the zero level.

At this point, the processings of the low-band components EOFF and FOFF are complete, and the outputs AD_E and AD_F of the A/D converters 14 and 24 have been adjusted for balance. Here, to suppress the effects of disturbance noise and others and ensure improved adjustment accuracy, it is preferred that the steps from (S601) to (S606) and those from (S700) to (S708) be repeated until the number of times set in the second counter 311 is counted (S709: YES).

Thus, following the tracking balance adjustment according to the present invention, the tracking servo control is enabled again. When information, recorded in the optical disk, is read with laser beams emitted from the laser element of the optical pickup, the tracking servo control is carried out based on the tracking error signal that has been subjected to the tracking balance adjustment.

<Example of the Effects>

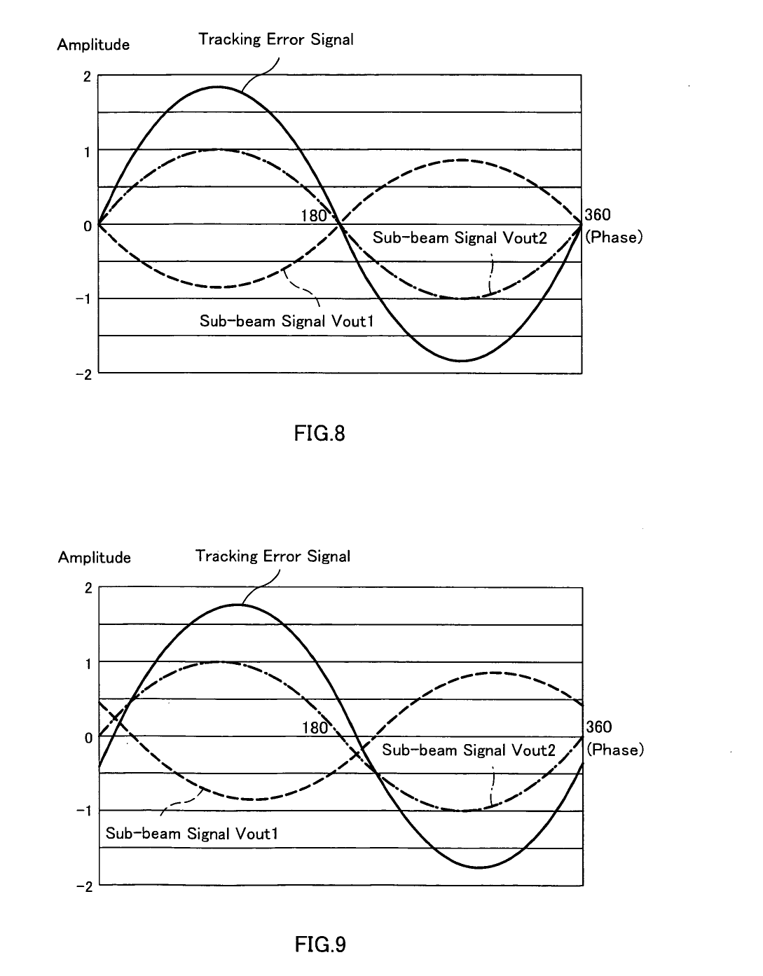

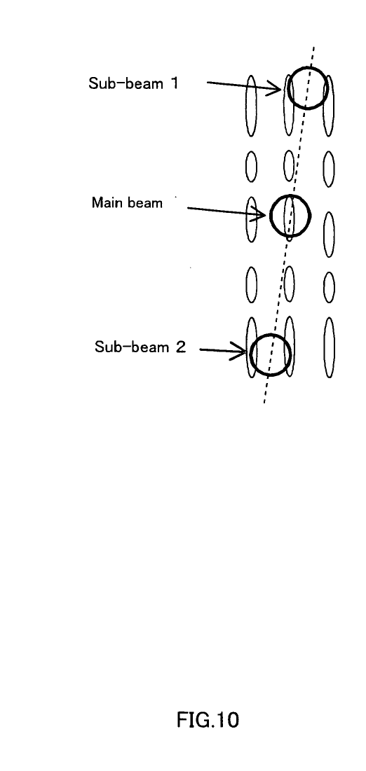

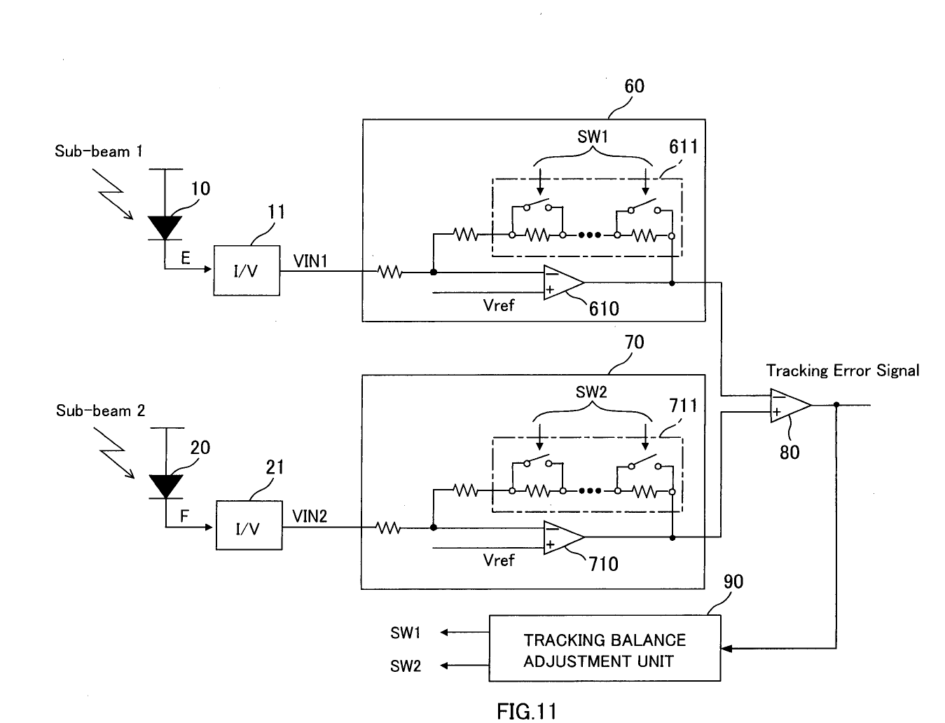

The sub-beam signals Vout1 and Vout2, that are the outputs of the LPFs 13 and 23 following the tracking balance adjustment according to the present invention, and the tracking error signal present, for example, the waveforms as illustrated in FIGS. 8 and 9.

FIG. 8 illustrates the sub-beam signals Vout1 and Vout2 when the amplitude levels and phases thereof agree with each other, whereas FIG. 9 illustrates the sub-beam signals Vout1 and Vout2 when the amplitude levels and phases thereof do not agree with each other. As illustrated in FIGS. 8 and 9, when a proper balance is kept between the positive and negative polarity levels of the sub-beam signals Vout1 and Vout2 relative to the zero level irrespective of the amplitude levels and phases of the sub-beam signals Vout1 and Vout2, then a proper balance can also be kept between the positive and negative polarity levels of the tracking error signal relative to the zero level. Then, the balance adjustment of the tracking error signal suppresses off-track resulting from a side slide during the tracking servo pull-in or a disturbance (vibrations) during the tracking servo operation.

Thus, the present invention eliminates the needs for the variable gain amplifiers 60 and 70 having the ladder resistors 611 and 711 that are large in circuit scale, and the logic for switching ON/OFF the switches provided in the ladder resistors 611 and 711 as illustrated in the conventional example (see FIG. 11), thus allowing for the tracking balance adjustment through a simple arrangement consisting of adjusting the offsets of the amplifiers 12 and 22. Therefore, the tracking balance adjustment device according to the present invention enables the integration through the CMOS process while suppressing the circuit scale expansion.

The tracking balance adjustment according to the present invention is not conducted using the tracking error signal itself as in the conventional example (see FIG. 11). Instead, the adjustment is carried out through two independent offset adjustments; the offset adjustment of the amplifier 12 using the signals associated with the sub-beam 1 (e.g., AD_E) and the offset adjustment of the amplifier 22 using the signals associated with the sub-beam 2 (e.g., AD_F). This ensures more elaborate tracking balance adjustment as compared to the conventional adjustment, thus providing improved adjustment accuracy.

When detecting the DC components of the outputs AD_E and AD_F of the A/D converters 14 and 24 based on the maximum and minimum values, the tracking balance adjustment according to the present invention allows such detection through a simple comparison of which value is larger or smaller. This speeds up the tracking balance adjustment process while suppressing the processing load of the DSP 30. On the other hand, when detecting the DC components of the outputs AD_E and AD_F of the A/D converters 14 and 24 through the LPF operation process, the tracking balance adjustment according to the present invention can suppress the effect of disturbance noise thanks to the LPF operation process, even if such noise, a high-frequency component, is superimposed on the DC components. This ensures improved accuracy in the tracking balance adjustment.

Further, the tracking balance adjustment according to the present invention stabilizes the DC component of the tracking error signal near the zero level. Therefore, if the tracking balance adjustment device according to the present invention is integrated through the low-voltage CMOS process, the dynamic range can, needless to say, be utilized effectively.

While embodiments of the present invention have been described, it should be understood that the aforementioned embodiments are intended for easy understanding of the present invention and not intended for restrictive interpretation of the invention. The present invention can be changed or modified without departing from the essence thereof and includes the equivalents thereof.

1. A tracking balance adjustment device for carrying out a balance adjustment, when laser beams emitted from a laser element are caused to track a track on the optical disk, to bring a DC component of a tracking error signal equal to a preset DC reference value by obtaining two photodetection signals opposite to each other in phase that represent a deviation in the tracking based on return beams of the laser beams from the optical disk and carrying out the tracking servo control based on the tracking error signal obtained from the difference between the two photodetection signals, the tracking balance adjustment device comprising:
a first amplifier operable to amplify one of the photodetection signals;
a second amplifier operable to amplify the other photodetection signal; and
a tracking balance adjustment unit operable to adjust the offset of the first amplifier so as to bring the DC component detected from the output of the first amplifier equal to the DC reference value and to adjust the offset of the second amplifier so as to bring the DC component detected from the output of the second amplifier equal to the DC reference value.

2. The tracking balance adjustment device of claim 1, wherein
the tracking balance adjustment unit obtains maximum and minimum values of the outputs of the first and second amplifiers respectively and adjusts the respective offsets of the first and second amplifiers so as to set the respective intermediate value between maximum and minimum values as the DC reference value.

3. The tracking balance adjustment device of claim 2, wherein
the tracking balance adjustment unit repeats the offset adjustment of the first and second amplifiers a preset number of times.

4. The tracking balance adjustment device of claim 2, wherein
the tracking balance adjustment unit obtains the respective maximum and minimum values during a preset time period.

5. The tracking balance adjustment device of claim 2, wherein
the first and second amplifiers are operational amplifiers supplied at inverting input terminals with the photodetection signals via input resistors and supplied at the inverting input terminals with amplified outputs via feedback resistors, wherein
when adjusting the offset of the first amplifier, the tracking balance adjustment unit supplies a control voltage corresponding to the difference between the intermediate value obtained from the output of the first amplifier and the DC reference value to a non-inverting input terminal of the first amplifier, and wherein
when adjusting the offset of the second amplifier, the tracking balance adjustment unit supplies a control voltage corresponding to the difference between the intermediate value obtained from the output of the second amplifier and the DC reference value to the non-inverting input terminal of the second amplifier.

6. The tracking balance adjustment device of claim 1, wherein
the tracking balance adjustment unit extracts low-band frequency components lower than a given cutoff frequency from the outputs of the first and second amplifiers, and adjusts the offsets of the first and second amplifiers so as to set the extracted low-band frequency components as the DC reference value.

7. The tracking balance adjustment device of claim 6, wherein
the tracking balance adjustment unit repeats the offset adjustment of the first and second amplifiers a preset number of times.

8. The tracking balance adjustment device of claim 6, wherein
the tracking balance adjustment unit repeatedly extracts the low-band frequency components during a preset time period.

9. The tracking balance adjustment device of claim 6, wherein
the first and second amplifiers are operational amplifiers supplied at inverting input terminals with the photodetection signals via input resistors and supplied at the inverting input terminals with amplified outputs via feedback resistors, wherein
when adjusting the offset of the first amplifier, the tracking balance adjustment unit supplies a control voltage corresponding to the difference between the low-band frequency component obtained from the output of the first amplifier and the DC reference value to the non-inverting input terminal of the first amplifier, and wherein
when adjusting the offset of the second amplifier, the tracking balance adjustment unit supplies a control voltage corresponding to the difference between the low-band frequency component obtained from the output of the second amplifier and the DC reference value to the non-inverting input terminal of the second amplifier.
